(19) United States
(12) Patent Application Publication
(10) Pub. No.: US 2003/0176279 A1
(43) Pub. Date: Sep. 18, 2003

(54) Method for fixing and immobilising a catalyst on a support

(76) Inventors: Isabelle Baudin, Nanterre (FR); Makram T. Suidan, Cincinnati, OH (US); Ganesh Balasubramanian, Cincinnati, OH (US); Jean-Michel Laine, Ecquevilly (FR)

Correspondence Address: Morris Liss, Pollock Vande Sande & Amernick, PO Box 19088, Washington, DC, 20036-3425, US

(21) Appl. No.: 10/181,036

(22) PCT Filed: Dec. 13, 2000
(86) PCT No.: PCT/FR00/03507

(30) Foreign Application Priority Data
Jan. 12, 2000 (FR) 00/00355

(51) Int. Cl. B01J 37/02

(52) U.S. Cl. 502/325; 502/439

(57) ABSTRACT

A process for the immobilization of a catalyst, in particular an oxidation or synthesis catalyst, on supports making it possible to bring said catalysts into contact with solutions or liquids being treated, characterized in that the deposition of the catalyst is carried out by:

dipping the support in a fluid mixture of powder formed from the catalyst and from a precursor of said catalyst, that is to say from a complex organic compound of the catalyzing metal element;

withdrawal at a controlled rate of the support after immersion in said mixture,

drying at ambient temperature,

heat treatment of the support, thus impregnated with the catalyst, under conditions which provide for the adhesion of said catalyst to its support.

The present invention relates to a process for fixing a catalyst to a support which makes it possible to bring said catalyst, for example an oxidation or synthesis catalyst, into contact with solutions or liquids being treated and to provide easy separation therefrom after treatment.

In FR-A-2 760 445, the present applicant disclosed and claimed a process for the treatment of water comprising organic micropollutants and microorganisms, which consists in carrying out photocatalysis on a film of water, formed on a surface to which a thin layer of photocatalyst has been fixed beforehand, in the presence of UV radiation directed on the film of water.

In this prior publication, the disclosure was made, for forming the film of water, of a technique consisting in rotating disks covered with the photocatalyst, which disks are mounted on a horizontal axis and are partially immersed in the water to be treated. By their rotation, the disks fix a thin film of water which is entrained out of the water. This thin film is then in the presence simultaneously of the photocatalyst and of the UV radiation.

The use of this process presents the problem of the development of an effective process for fixing and immobilizing the photocatalyst on the rotating support which makes it possible to offer the greatest possible reaction surface area. This problem is solved by the invention, it being clearly understood that the latter applies not only to the invention disclosed in FR-A-2 760 445 but also to any application employing catalysts immobilized on a support. According to the current state of the art, solid catalysts for photocatalysis in aqueous medium can be employed in various ways:

in the form of suspensions of a fine powder (of the order of a few nm), generating very high specific surface areas and therefore high active surface areas for the catalysis: the disadvantage here is the difficulty of separating the catalyst for recovery and recycling.

in the form of a filter bed; this method is very easy to operate and there is no problem of separation/recovery of the material; however, in this case, a minimum grain size (greater than 1 mm) is required in order to prevent excessively high blocking of the bed and thus a high hydraulic head loss; as a direct consequence of the increase in the size of the particles, the active catalyst surface area is relatively low.

in the form of a powder or grains fixed to a support; this technique exhibits the advantage of making it possible to choose the support suited to the process and of allowing convenient implementation, the separation of the catalyst and of the liquid phase being easy; on the other hand, serious difficulties are encountered in fixing the catalyst to the support, especially in photocatalysis, where the UV rays in the more or less long term oxidize the catalysts/potential support binders (various bonding media, resin, adhesives);

in the form of a deposit on a support starting, for example, from a titanium organic solution preparation (sol/gel reaction); the advantage of this technique is that of carrying out a direct deposition on the support (various possible materials, resistant to a deposition temperature of greater than 500° C., for example glass, steel, and the like), without it being necessary to employ adhesives or other binders; the deposit obtained by this technique exhibits good mechanical and chemical strength of the layer formed at the surface of the support; the major disadvantage of this technique is a low activity of the titanium oxide deposited by this process, due to a low specific surface area of the deposit formed and consequently to a mediocre “accessibility” to the catalyst; it is possible, of course, to deposit several successive layers and consequently to acquire better control of the thickness of the deposit and its roughness, but without completely surmounting the disadvantages described above.

Consequently, to overcome the disadvantages of the solutions according to the prior art, the present invention introduces a process for the immobilization of a catalyst, in particular an oxidation or synthesis catalyst, on supports making it possible to bring said catalysts into contact with solutions or liquids being treated, characterized in that the deposition of the catalyst is carried out by:

dipping the support in a fluid mixture of powder formed from the catalyst and from a precursor of said catalyst, that is to say from a complex organic compound of the catalyzing metal element;

withdrawal at a controlled rate of the support after immersion in said mixture,

drying at ambient temperature,

heat treatment of the support, thus impregnated with the catalyst, under conditions which provide for the adhesion of said catalyst to its support.

According to the present invention, the rate of withdrawal of the support, after immersion in said mixture, is of the order of 2 to 30 cm.min⁻¹, preferably 8 to 18 cm.min⁻¹.

As it is understood, the invention as specified above uses the “sol/gel deposition” technique by employing deposition precursors, for example organic compounds of titanium, when the catalyst is TiO₂, or of any other catalyzing metal element, and by enriching the solution with the powder formed from the catalyst. The process which is a subject matter of the invention combines the advantages of the deposition by a sol/gel reaction and those resulting from the use of a catalyst in the form of a powder. The advantages introduced by the invention are reflected in particular by a high specific surface area, a high activity, the stability of the deposit on various supports and the ease of preparation of the deposit. Furthermore, according to the invention, it is possible to carry out several successive depositions, which makes it possible to control the thickness and the roughness of the deposit. Another advantage introduced by the use of the invention is the variety of the supports to which it can be applied: glass, ceramics, metals, ordinary or stainless steel, and the like, and their presentation in the form of plates, disks, beads, and the like.

An example of the implementation of the process according to the invention, carried out experimentally in the laboratory, has been described below. This implementational example is easily transferable to the industrial scale.

The starting point was the preparation of a sol using titanium isopropoxide, isopropanol, diethanolamine and TiO₂ powder.

A 0.5M solution of titanium isopropoxide in isopropanol was prepared and an appropriate amount of diethanolamine was subsequently added thereto (diethanolamine/titanium isopropoxide molar ratio of 4). The solution was stirred for two hours at ambient temperature and then water was added according to a water/isopropoxide molar ratio of 2. A sol exhibiting a high viscosity was thus obtained.

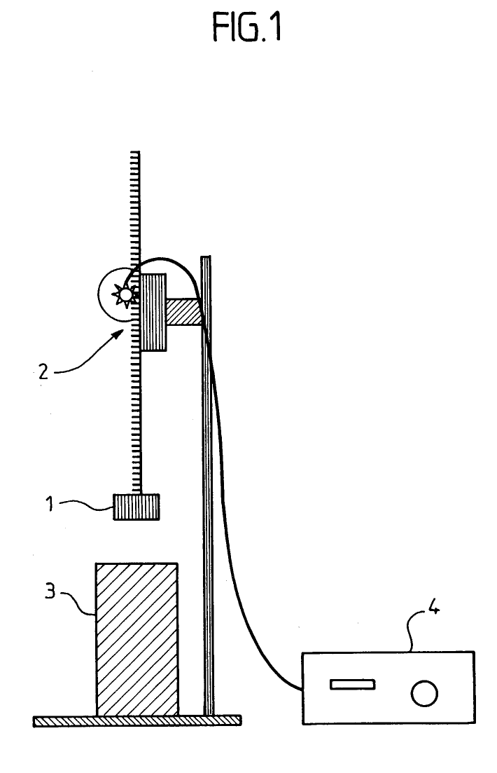

TiO₂ powder was added to the sol in a proportion of an amount of 30 g/l. This addition was carried out with vigorous stirring of the sol while slowly adding the measured amount of TiO₂ powder. A sol-gel enriched in TiO₂ powder was thus obtained and was deposited on a support made of stainless steel using the device illustrated in FIG. 1 of the appended drawings.

After cleaning and drying, a plate 1 made of stainless steel was fixed to the end of a rack-and-pinion withdrawal system 2 which makes it possible to immerse the plate 1 in a container filled with the sol-gel solution prepared beforehand. The motor of the rack-and-pinion system was under the direction of a control mechanism 4 which makes it possible to control the rate of withdrawal of the plate 1 after immersion. The rate of withdrawal was constant and 12.8 cm per minute. The deposition of a uniform film of sol on the plate was obtained. The deposit was subsequently dried for 24 hours at ambient temperature.

The plate coated with the catalyst layer was subsequently subjected to a heat treatment in an oven in which the temperature was increased by 3° C. per minute up to 100° C. and then maintained at 100° C. for one hour. Subsequently, the temperature was again increased by 3° C. per minute until 600° C. was reached, which value was maintained subsequently for one hour. Finally, the oven was allowed to cool to ambient temperature. A film of TiO₂ on the support plate was obtained. The deposition process was repeated several times until TiO₂ films exhibiting the desired thickness were gradually obtained.

The plate thus coated with catalyst according to the process which is a subject matter of the invention was compared with a plate coated with the same catalyst but obtained by the use of the process according to the prior sol/gel technique, without the addition of TiO₂ powder.

The comparative results are given in the following two tables:

TABLE 1

| Prior technique | |
|---|---|
| Number of deposition | Thickness of the |
| operations | deposit in μm |
| 2 | 8 |
| 3 | 10-12 |
| 4 | 15 |
| 8 | 34 |

TABLE 2

| Process according to | |
|---|---|
| the invention | Thickness of the |
| Number of depositions | deposit in μm |
| 2 | 70 |
| 3 | 110 |
| 4 | 150 |
| 8 | 300 |

By virtue of the invention, much thicker deposits are obtained, the thickness of which is fully controlled. Furthermore, tests have shown that the deposits produced according to the invention exhibit a much greater hardness than those obtained according to the prior technique used.

As regards the catalytic activity, comparative tests carried out by the applicant have clearly shown that the plates coated with a catalyst deposit according to the process of the invention exhibit a much higher activity (of the order of 2 to 6 times higher) than the plates prepared according to the prior technique used.

Apart from those already specified above, the invention introduces the following advantages:

the catalyst, for example TiO₂, can be immobilized on a wide variety of supports, among which may be mentioned stainless steel, metals, alloys, glass, ceramics or optical fibers;

the process can be used to immobilize the catalyst on any surface of whatever shape which can come into contact with the sol. This eliminates the limitation due to the shape of the support which is encountered in the implementation of the prior techniques;

the process can be used to immobilize any powder catalyst: TiO₂, ZnO, MnO₂, Fe₂O₃, based on platinum, doping metals or semiconductors;

possibility of fixing catalysts of any particle size, porosity;

use of simple and inexpensive equipment for the deposition;

excellent mechanical characteristics of the deposits, which reduces the frequency of the replacements of the catalyst;

excellent catalytic activity, which leads to a reduction in the dimensions of the reactors, in particular of the reactors used in the implementation of the process disclosed in FR-A-2 760 445, the UV radiation being, furthermore, used more efficiently, which reduces the energy costs.

It remains, of course, that the invention is not limited to the implementational examples described and/or mentioned above but that it encompasses all the alternative forms thereof.

1. A process for the immobilization of a catalyst, in particular an oxidation or synthesis catalyst, on supports making it possible to bring said catalysts into contact with solutions or liquids being treated, wherein the deposition of the catalyst is carried out by:
dipping the support in a fluid mixture of powder formed from the catalyst and from a precursor of said catalyst, that is to say from a complex organic compound of the catalyzing metal element;
withdrawal at a controlled rate of the support after immersion in said mixture,
drying at ambient temperature,
heat treatment of the support, thus impregnated with the catalyst, under conditions which provide for the adhesion of said catalyst to its support.

2. The process as claimed in claim 1, wherein the thickness and the roughness of the catalyst layer deposited on its support are controlled by carrying out several successive depositions.

3. The process as claimed in claim 1, wherein the rate of withdrawal of the support after immersion in said mixture is of the order of 2 to 30 cm.min⁻¹, preferably 8 to 18 cm.min⁻¹.

4. The process as claimed in claim 1, wherein the heat treatment of the support impregnated with catalyst consists in heating by 3° C. per minute up to 100° C. and maintaining at 100° C. for one hour, followed by heating up to 600° C. for one hour, and finally cooling to ambient temperature.
